(19) United States
(12) Patent Application Publication
(10) Pub. No.: US 2014/0367326 A1
(43) Pub. Date: Dec. 18, 2014

(54) THIN-FILM NANO-COMPOSITE MEMBRANE WITH MESOPOROUS SILICA NANOPARTICLES

(71) Applicants: BAOLIN DENG, COLUMBIA, MO (US); JUN YIN, COLUMBIA, MO (US)

(72) Inventors: BAOLIN DENG, COLUMBIA, MO (US); JUN YIN, COLUMBIA, MO (US)

(73) Assignee: THE CURATORS OF THE UNIVERSITY OF MISSOURI, COLUMBIA, MO (US)

(21) Appl. No.: 14/305,483

(22) Filed: Jun. 16, 2014

Related U.S. Application Data
(60) Provisional application No. 61/956,686, filed on Jun. 14, 2013.

(51) Int. Cl. B01D 71/04; B01D 61/02; B01D 69/14

(52) U.S. Cl. CPC B01D 71/04; B01D 69/148; B01D 61/025; B01D 61/027
USPC 210/500.26; 427/333

(57) ABSTRACT

The present invention is directed to a filtration membrane comprising a thin polymeric membrane film in which mesoporous silica nanoparticles are embedded. The membrane may be a thin-film nanocomposite membrane useful for reverse osmosis or nanofiltration. The present invention is also directed to a filtration membrane comprising a thin polymeric membrane film formed from a solution comprising less than 0.1 wt % mesoporous nanoparticles.

### CROSS-REFERENCE TO RELATED APPLICATIONS

This application is based on and claims priority to U.S. Provisional Application Ser. No. 61/956,686, filed on Jun. 14, 2013, which is incorporated herein by reference in its entirety.

### STATEMENT REGARDING FEDERALLY SPONSORED RESEARCH OR DEVELOPMENT

The invention was made with Government support under Grant No. C1935026 awarded by the U.S. Department of Agriculture. The Government has certain rights in the invention.

### BACKGROUND OF THE INVENTION

1. Field of the Invention

The invention is directed to the field of membrane filtration, more particularly to the field of water reclamation, desalination, or other separation/treatment processes.

2. Description of Related Art

Reverse osmosis (RO) and nanofiltration (NF) membranes have been widely used for water reclamation, desalination and other separation processes. The thin-film composite (TFC) membrane is a major type of RO and NF membranes, which consists of a thin-film layer supported on a porous substrate (support layer). High water flux, high solute rejection, minimum membrane fouling, and excellent mechanical durability are major attributes of a good TFC membrane. Many efforts have been devoted to modify polymer materials, develop new membranes, and implement proper pre-treatments in order to improve the membrane performance. Because of the multilayer structure of TFC membranes, replacing or modifying the support layer is one way to improve their performance. Polysulfone (PSU) is a dominant material used for the support layer, which shows good thermal and chemical stabilities with low cost. Optimizing its structure through modified fabrication process, or placing it with other polymer such as the plasma-treated polyvinylidene fluoride (PVDF) have been reported to improve the TFC membrane performance. The other approach is to change properties of the thin-film layer. Uses of different interfacial polymerization (IP) conditions, monomers and physical coating or chemical modifications could be explored to optimize the membrane performances.

Recently, the thin-film nanocomposite (TFN) membrane, in which nanomaterials are embedded in the thin-film layer to improve the membrane physicochemical properties and performance, has been under active development. Joeng et al. introduced Zeolite-A nanoparticles (NPs) into TFN membranes, resulting in higher water flux with constant salt rejection. They hydrophilic and negatively charged Zeolite-A NPs provided the preferential flow paths for water molecules and the combination of steric and Donnan exclusion maintained high salt rejection. The effects for crystal size of zeolite in the TFN membrane were investigated, and small sized NPs (˜100 nm) were found to best match the thin-film thickness and provide permeability enhancements. Silica (SiO₂) NPs improved membrane thermal stability and performance, TiO₂ increased surface hydrophilicity and enhance water flux, and silver (Ag) NPs promoted the anti-biofouling properties. However, the performance of the TFN membrane is still in need of improvement.

### BRIEF SUMMARY OF THE INVENTION

The present invention is directed to a filtration membrane comprising a polymeric membrane film with mesoporous silica nanoparticles embedded within the film. In certain aspects of the invention, the polymeric film is formed form a solution comprising the nanoparticles, where the nanoparticles comprises less than 0.1 wt % of the solution, between 0.01 and 0.1 wt % of the solution or between 0.04 to 0.05 wt % of the solution. The polymeric film is preferably formed form the nanoparticle solution and a monomer solution containing a first monomer, where the nanoparticle solution also contains a second monomer.

In certain aspects of the invention, the mesoporous silica nanoparticles have a diameter between 2 and 300 nm, between 2 and 200 nm, between 10 and 200 nm, or between 80 and 120 nm. In certain aspects of the invention, the mesoporous silica nanoparticles have a pore size between 2 and 50 nm in diameter, between 2 and 20 nm or between 3 and 4 nm.

In certain aspects of the invention, the mesoporous silica nanoparticles have pores of at least two sizes, which may be both micropores and mesopores. The pore sizes may be selected form the group consisting of 1.5-2.0 nm, 2.0-2.5 nm and 3.5-4.5 nm.

In certain aspects of the invention the nanoparticles are MCM-41 silica nanoparticles. The nanoparticles may be spherical.

In certain aspects of the invention, the filtration membrane is a thin-film nanocomposite membrane. The membrane may be a reverse osmosis or nanofiltration membrane, or other type of membrane. The filtration membrane may further contain a porous substrate supporting said film.

In certain aspects of the invention, the filtration membrane includes a polymeric membrane film with mesoporous nanoparticles embedded within the film, wherein the nanoparticles include nanoparticles that are not silica. The polymeric membrane film is formed from (a) a monomer solution comprising a first monomer and (b) a nanoparticle solution containing the nanoparticles and a second monomer, where the nanoparticles comprise less than 0.1 wt % of the nanoparticle solution. The nanoparticles preferably comprise between 0.01 and 0.1 wt % of the nanoparticle solution or between 0.04 to 0.05 wt % of the nanoparticle solution.

In certain aspects of the invention, the polymeric membrane film of the invention is made from the process of providing a substrate, applying a monomer solution containing a first monomer to a surface of the substrate, and applying a nanoparticle solution comprising a second monomer and mesoporous silica nanoparticles to the surface of the substrate to form a polymeric membrane film on the substrate. The nanoparticles preferably comprise between 0.01 and 0.1 wt % of the nanoparticle solution.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a cross-sectional view of one embodiment of the filtration membrane of the present invention.

FIG. 2 depicts (a) XRD patterns and (b) N₂ adsorption/desorption isotherm and pore size distribution of mesoporous silica nanoparticles of the present invention and non-porous spherical silica nanoparticles.

FIG. 3 depicts (a) a SEM image and (b) a TEM image of mesoporous silica nanoparticles of the present invention and (c) a TEM image of non-porous spherical silica nanoparticles.

FIG. 4 depicts ATR FT-IR spectra of (a) a PSU support layer; (b) a thin-film composite membrane without nanoparticles (TFC); (c)-(e) thin-film nanocomposite membranes (TFN) with varying concentrations of MCM-41 silica nanoparticles.

FIG. 5 depicts images of surface morphologies of (a) a PSU support layer, (b) a TFC and (c)/(d) TFN membranes. All scales were represented in 2 μm.

FIG. 6 depicts TEM images of the cross-section of (a) a TFC and (b) TFN membranes.

FIG. 7 depicts (a) water contact angles and RMS roughness for TFN membranes and (b) AFM images of a PSU support layer, and TFC and TFN membranes

FIG. 8 depicts potential of a PSU support layer, and TFC and TFN membranes.

FIG. 9 depicts membrane water flux and salt rejection of TFN membranes.

FIG. 10 depicts TEM images of bimodal mesoporous silica nanoparticles of the present invention.

FIG. 11 depicts N₂ adsorption/desorption isotherm and pore size distribution of bimodal mesoporous silica nanoparticles of the present invention.

FIG. 12 depicts ATR FT-IR spectra of a TFC membrane and a TFN membrane comprising bimodal mesoporous silica nanoparticles of the present invention.

FIG. 13 depicts SEM images of a PSU support layer, and TFC and TFN membranes.

FIG. 14 depicts contact angles of TFN membranes as a function of bimodal silica nanoparticle loading.

FIG. 15 depicts AFM images of a PSU support layer, and TFC and TFN membranes.

FIG. 16 depicts water flux and salt rejection of TFN membranes.

### DETAILED DESCRIPTION OF PREFERRED EMBODIMENT

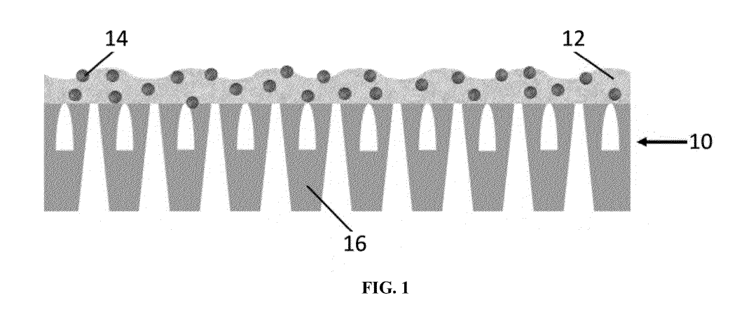

The present invention is directed to a filtration membrane 10 comprising a polymeric membrane film 12 with mesoporous silica nanoparticles 14 embedded within the film. In one embodiment of the invention shown in FIG. 1, the filtration membrane 10 is preferably a thin-film nanocomposite membrane, comprising a porous substrate 16 supporting the polymeric membrane film 12.

In one aspect of the invention, the polymeric membrane film is formed form a nanoparticle solution comprising the nanoparticles, where the nanoparticles comprise less than 0.1 wt % of the solution, between 0.01 and 0.1 wt % of the solution or between 0.04 to 0.05 wt % of the solution. The polymeric film is preferably formed form the nanoparticle solution and a monomer solution containing a first monomer, where the nanoparticle solution also contains a second monomer. In certain aspects of the invention, the mesoporous silica nanoparticles comprise less than 0.1%, less than 0.09%, less than 0.08%, less than 0.07%, less than 0.06 or less than 0.05 by weight of the nanoparticle solution. The mesoporous silica nanoparticles are preferably distributed uniformly throughout the resulting polymeric membrane film.

When used herein, the term “mesoporous” means having a pore size between 2 and 50 nm in diameter, and “mesopores” are pores having a diameter between 2 and 50 nm. In certain embodiments, the mesoporous silica nanoparticles of the present have a pore size between 2 and 20 nm, between 2 and 10 nm, between 2 and 5 nm, between 4 and 5 nm or between 3 and 4 nm. It should be understood that a mesoporous nanoparticle may contain both mesopores and micropores. However, in certain embodiments, the mesoporous silica nanoparticles contain only mesopores.

In certain embodiments the mesoporous silica nanoparticles comprise pores of at least two sizes referred to herein as “bimodal.” In such embodiments, the pores may include both micropores and mesopores. When used herein, “micropores” are pores having a diameter less than 2 nm and “microporous” means having a pore size less than 2 nm in diameter. The micropores are preferably between 1.5 and 2.0 nm, and the mesopores are between 2.0 and 4.5 nm. In certain aspects, the mesopores are between 2.0 and 2.5 nm, 2.5 and 3.5 nm, or 3.5 and 4.5 nm in diameter.

The mesoporous silica nanoparticles of the present invention can be made by any method known in the art or hereafter developed. In certain embodiments, the mesoporous silica nanoparticles are ordered mesoporous nanoparticles, preferably possessing a two-dimensional hexagonal ordered structure, tunable size and controllable morphology. In certain aspects of the invention, the mesoporous silica nanoparticles are MCM-41 silica nanoparticles. MCM-41 silica nanoparticles may be made using the method disclosed in Q. Cai, et al, Dilute solution routes to various controllable morphologies of MCM-41 silica with a basic medium, CHEM. MATER. 13 (2001) 258-263, incorporated herein solely with respect to such disclosure. Any other mesoporous silica nanoparticles with a size smaller than 300 nm are suitable for use in the present invention.

In certain aspects of the invention, the nanoparticles have a diameter between 2 and 300 nm, between 2 and 200 nm in diameter, between 10 and 200 nm, between 80 and 120 nm in diameter, or about 100 nm in diameter. In certain aspects of the invention the nanoparticles are spherical. The term “spherical” does not require a perfect sphere but encompasses structures generally spherical in shape.

As noted above, the filtration membrane of the present invention may be a thin-film nanocomposite membrane. In certain aspects of the invention, the filtration membrane is a reverse osmosis or nanofiltration membrane.

In certain aspects of the invention, the nanoparticles are not silica but may be any ordered mesoporous nanoparticles. The non-silica nanoparticles also comprise less than 0.1 wt % of the nanoparticle solution used to prepare the polymeric membrane film, between 0.01 and 0.1 wt % of the solution, or between 0.04 to 0.05 wt % of the solution. In such aspects of the invention, the mesoporous nanoparticles may comprise less than 0.1%, less than 0.09%, less than 0.08%, less than 0.07%, less than 0.06 or less than 0.05 by weight of the solution. The ordered mesoporous nanoparticles can be ordered carbon mesporous nanoparticles, or ordered mesoporous nanoparticles of other materials. The non-silica ordered mesoporous nanoparticles may have any or all of the characteristics described herein with respect to mesoporous silica nanoparticles. All other characteristics of the polymeric membrane film and filtration membrane discussed with respect to the silica mesoporous nanoparticles also apply to the non-silica mesoporous nanoparticles.

General characteristics of thin-film nanocomposite membranes are known in the art. For example, the polymeric membrane film is preferably a thin film having a thickness of less than 500 nm, preferably around 300 nm. The polymeric membrane film of the invention can be made from the process of providing a substrate, applying a monomer solution containing a first monomer to a surface of the substrate, and applying a nanoparticle solution comprising a second monomer and mesoporous silica nanoparticles to the surface of the substrate to form a polymeric membrane film on the substrate. The nanoparticles preferably comprise between 0.01 and 0.1 wt % of the nanoparticle solution. Preferably the monomer solution comprises a monomeric aromatic polyamine as the first monomer and the nanoparticle solution comprises a monomeric aromatic acyl halide as the second monomer, as discussed in more detail below. Preferably the monomer solution and the nanoparticle solution are used in an in situ interfacial polymerization process.

The polymeric membrane film may be a polyamide thin film formed by an in situ interfacial polymerization process known in the art, although any other methods for forming the membrane film known in the art or hereafter developed may be used consistent with the present invention. Further, other monomers or polymers may be used to form the polymeric membrane film consistent with the present invention, such as through interfacial polymerization between a monomeric aromatic polyamine and a monomeric aromatic acyl halide. The monomeric aromatic polyamine could be phenylenediamine, phenylenetriamine, cyclohexane diamine, cyclohexane triamine, piperazine, bipiperidine or any other aromatic compound having —NH₂— or —NH— groups. The acyl halide could be trimesoyl chloride. The nanoparticle solution may be subjected to sonication to disperse the nanoparticles in the membrane film. In one aspect of the invention, aqueous m-phenylenediamine and organic trimesoyl chloride-nanoparticle mixture solutions may be used in the interfacial polymerization process to form a polyamide membrane film. In certain embodiments polymers can be used in place of the monomers.

The porous substrate may be any suitable substrate known in the art or hereafter developed, including a layer comprising polysulfone or plasma modified polyvinylidene fluoride. The porous substrate may be formed by any method known in the art or hereafter developed, including the phase inversion method.

The filtration membranes of the present produce a higher liquid flux, higher filtration efficiency and less energy consumption than standard thin-firm nanocomposite membranes. Furthermore, although the mesoporous silica nanoparticles of the present invention are hydrophilic, the properties of the filtration membrane of the present invention with respect to permeate water flux were surprisingly improved over membranes incorporating non-porous hydrophilic silica nanoparticles, while maintaining high rejection of NaCl and Na₂SO₄. This suggests the internal pores contribute significantly to the increase of water permeability.

Certain aspects of the present invention are illustrated by the following non-limiting examples.

### Example 1

### Preparation of MCM-41 Nanoparticles and Spherical Silica Nanoparticles

Cetyltrimethylammonium bromide (CTAB, 95%, Aldrich) and tetraethyl orthosilicate (TEOS, 98%, Sigma-Aldrich) were used as surfactant and silica source, respectively, for the synthesis of MCM-41. TEOS and aqueous ammonia solution (catalyst, 20-22%, Fisher Scientific) were used for the synthesis of spherical silica NPs.

MCM-41 NPs were synthesized as follows. A 3.5 mL of 2 M sodium hydroxide solution (NaOH, Aldrich) and 480 mL of DI water were mixed for 10 min, and 1.0 g of CTAB was added to mixture with stirring at 353 K for 30 min. Then, a 5 mL of TEOS was added drop-wise to the prepared solution. After 2 hrs of stirring, a white slurry mixture formed was centrifuged at 10,000 rpm for 10 min (5810R, Eppendorf Corp., Hamburg, Germany) and washed twice with DI water. The products were dried at ambient temperature and calcinated in air at 823K for 4 hrs.

The hydrolysis of TEOS in ethanol with ammonia as a catalyst was used to synthesize the spherical silica NPs. A 14 g of ammonia aqueous solution was mixed with 190 mL ethanol, and then 22.3 mL TEOS was added. After 4 hrs of stirring at room temperature (23±1° C.), the mixture was centrifuged at 10,000 rpm for 10 min. The product was washed twice with ethanol, dried and calcinated in air at 723K for 3 hrs. The final products (i.e., MCM-41 NPs and spherical silica NPs) were stored in a desiccator.

### Example 2

### Characterization of MCM-41 Nanoparticles and Comparison to Spherical Silica Nanoparticles

The crystalline structures of synthesized NPs were analyzed by an X-ray powder diffractometer (XRD, Ultima IV, Rigaku Americas Corp., The Woodlands, Tex.). The samples were scanned from 0.8° to 10° (20) with a step size of 0.02° and a count time of 1 s at each point. N₂ adsorption/desorption isotherms of NPs were carried out on QUADRASORB™ SI (Quantachrome Instruments, Boynton Beach, Fla.) at 77 K. The specific surface areas and pore size distributions were calculated by Brunauer-Emmett-Teller (BET) method and Density Functional Theory (DFT) method, respectively. Morphology and internal structure of NPs were examined by SEM (Quanta FEG 600, FEI Company, Hillsboro, Oreg.) and TEM (JEOL 1400, JEOL Ltd., Peabody, Mass.). SEM specimen was prepared by dropping NPs-ethanol mixture solution onto a silicon wafer. After complete drying at room temperature, the specimen was coated with platinum by a sputter coater (K575x, Emitech Ltd., Kent, England) at 20 mA for 1 min to increase conductivity. TEM samples of NPs were prepared by dropping NPs-ethanol mixture solution onto carbon coated copper grid and drying at the room temperature.

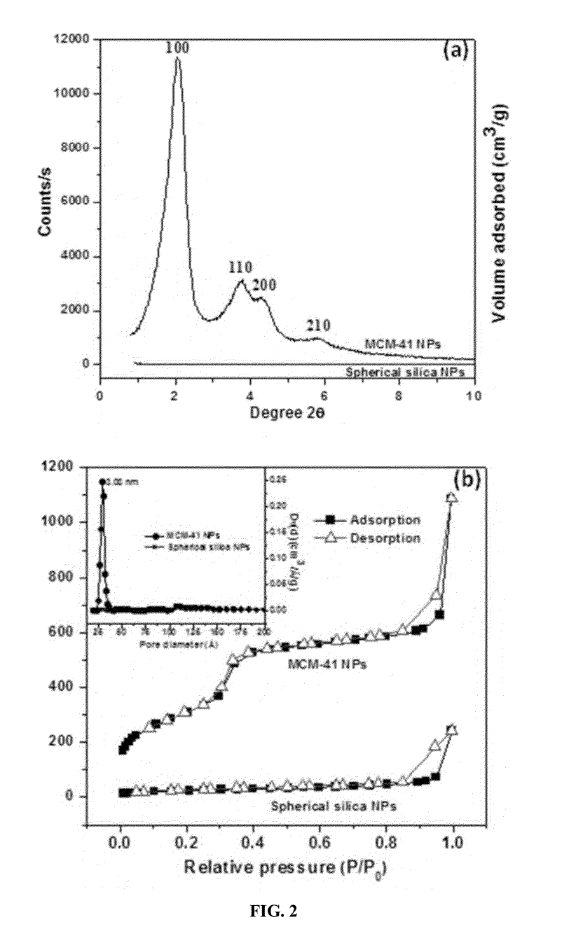

The small-angle XRD patterns of spherical silica and MCM-41 NPs are presented in FIG. 2. MCM-41 NPs showed four well-resolved peaks, consistent with the hexagonal lattice symmetry of MCM-41 structure. The pore diameter of synthesized MCM-41 NPs is about 3.85 nm. The results of BET analysis show that MCM-41 NPs has a large surface area (949.4 m²/g) compared to spherical silica NPs (72.7 m²/g). And the pore size inside MCM-41 NPs is around 3.03 nm while there is no internal pore structure inside spherical silica NPs, which is consistent with the result of XRD.

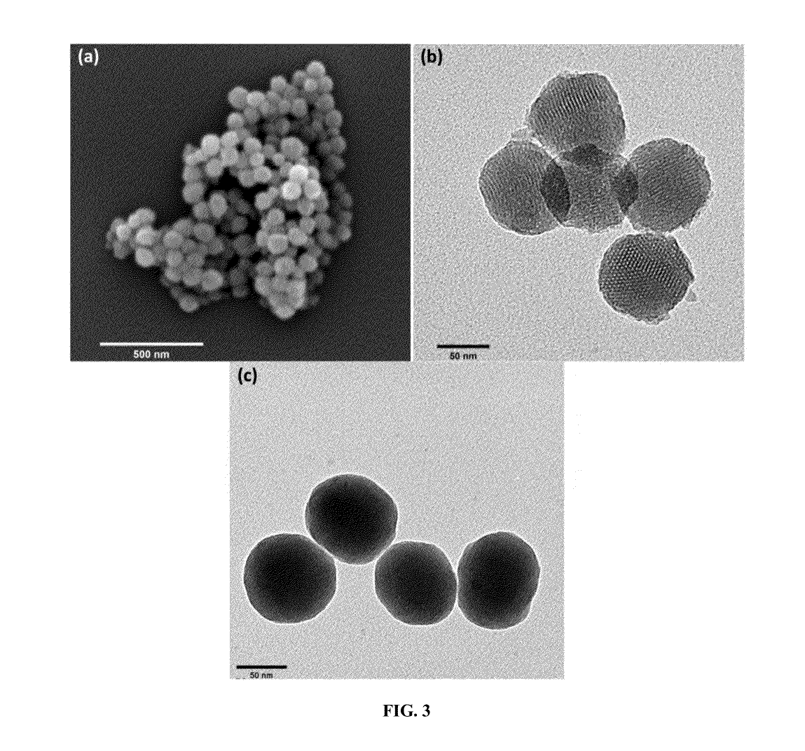

Both SEM (FIG. 3a) and TEM (FIG. 3b) micrographs demonstrated that MCM-41 NPs had near spherical shape. The size of particle was about 100 nm. Highly ordered hexagonal array and streak structure were detected inside particles. TEM image of spherical silica NPs (FIG. 3c) also showed a uniform spherical shape with an average particle size around 100 nm, but without internal pores. This was also consistent with the small-angle XRD pattern of spherical silica NPs that showed no peaks in the range from 0.8° to 10′ of 2θ (FIG. 2a).

### Example 3

### Preparation and Characterization of PSU Support Layer and TFN Membrane

PSU (Mw=35,000, Aldrich) pellets dissolved in N,N-dimethylformamide (DMF, 99.8%, Aldrich) were used as the casting solution to make the support layer. m-phenylenediamine (MPD, >99%, Aldrich) and trimesoyl chloride (TMC, >98.5%, Aldrich) were monomers used in the IP process. All chemicals were ACS reagents grade. Deionized (DI) water produced by Millipore DI system (Synergy 185, 18.2 MΩ·cm) was used for solution preparation and filtration study.

The PSU support layer was fabricated by the phase inversion method using 15 wt. % PSU-DMF casting solution. The casting solution was stirred at 50° C. for 6 hrs, and kept overnight for degassing. The clear solution was spread on a glass plate and casted by casting knife (EQ-Se-KTQ-150, MTI Corp., Richmond, Calif.) to approximately 100 μM of film thickness. Then, the glass plate was immediately immersed into a DI water bath (25° C.). The precipitated PSU support membrane was washed and stored in DI water at least 24 hrs until use.

For TFN membrane fabrication, the prepared PSU support layer was immersed in a 2.0 wt. % MPD-water solution for 3 min. Excess solution on the surface was removed by a rubber roller. Next, the MPD saturated PSU support layer was soaked in a 0.15 wt. % of TMC-hexane solution for 2 min, resulting in the formation of a PA thin-film layer. The amounts of NPs (MCM-41 or spherical silica NPs) dispersed in the TMC-hexane solution varied from 0 to 0.1 wt. %. A complete mixing of NPs in the TFC-hexane solution was achieved by ultrasonication for 1 hr. The TFN membranes were rinsed with pure hexane and cured at 80° C. in an oven for 5 min, and then stored in DI water at 5° C. The final products were named as M-TFN-x or S-TFN-x, where x denoted the concentration of filler in TMC solution during the IP process. For example, TFN membrane prepared by 0.05 wt. % MCM-41 NPs was named as M-TFN-0.05. The membrane prepared with 0% NPs was the TFC membrane.

SEM analysis of membrane surface was conducted using a piece of membrane dried at room temperature. The operational condition was identical with NPs analysis described in Example 2. To obtain the TEM cross-section, the membranes were embedded in Epon resin (Eponate 12, Ted Pella, Inc., Redding, Calif.) and cut by Reichert-Jung Ultracut E ultramicrotome (Reichert, Inc. Depew, N.Y.). The images were taken under 80 kV by using JEOL 1400. Hydrophilicity of membrane was assessed based on the measurement of pure water contact angles. The video contact angle system (VCA-2500 XE, AST products, Billerica, Mass.) was employed to perform the sessile drop method. At least six stabilized contact angles from different sites of each sample were obtained to calculate average contact angle and standard deviation. The functional groups of membrane surface were identified by attenuated total reflection Fourier transform infrared (ATR FT-IR) spectroscopy. Nicolet 4700 FT-IR (Thermo Electron Corporation, Waltham, Mass.) equipped with multi-reflection Smart Performer® ATR accessory was used for this analysis. All spectra included the wave numbers from 500 to 4000 cm⁻¹ with 128 scans at a resolution of 2.0 cm⁻¹. Quantitative surface roughness of the membrane was analyzed by atomic force microscopy (AFM5500, Agilent Technologies, Inc. Santa Clara, Calif.) with tapping mode in air. 100 μm² of surface area was tested and the root mean square (RMS) roughness was recorded. Tangential streaming potential was measured to calculate surface zeta (0 potential with 0.01 M potassium chloride (KCl, Fisher) used as an electrolyte solution. All measurements were carried out at room temperature (23±1° C.) and the solution pH was controlled at 5.8±0.2. The zeta potential was obtained by the classic Helmholtz-Smoluchowski (H—S) equation:

$$ζ = \frac{{E}_{S}}{Δ P} \frac{ηκ}{{ɛ}_{r} {ɛ}_{0}} \qquad ( 1 )$$

where Eₛ is the tangential streaming potential, ΔP is the pressure gradient, κ is the conductance of electrolyte solution, η is the liquid viscosity, ∈₀ is the vacuum permittivity, and ∈ᵣ is the relative dielectric constant.

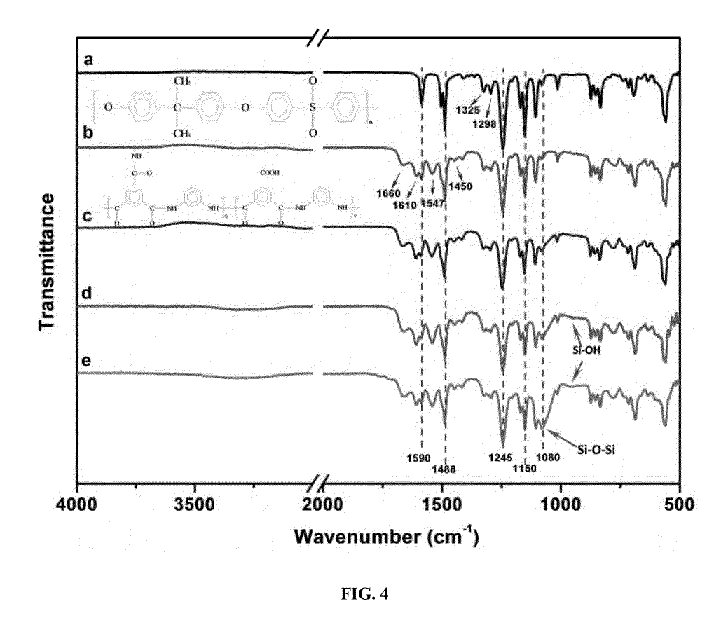

The ATR FT-IR spectra of (a) PSU support layer, (b) TFC, (c) M-TFN-0.05, (d) M-TFN-0.1, and (e) M-TFN-0.5 membranes are shown in FIG. 4. This result verified the existence of MCM-41 NPs in the membrane sample after interfacial polymerization process.

The SEM surface morphologies of the (a) PSU support layer, (b) TFC, (c) M-TFN-0.01 and (d) M-TFN-0.05 membranes are shown in FIG. 5. All scales were represented in 2 μm. The PSU support layer was porous and the pore size was distributed around 23.2±8.4 μm, based on the calculation by the software (ImageJ). After the IP process, PA thin-film layer coated on the PSU support layer by the reaction between MPD and TMC and resulted a leaf-like morphology (FIG. 5b-5d). The impregnation of MCM-41 NPs did not affect the overall morphology of thin-film layer in the tested concentration range, but partial aggregation of MCM-41 NPs was observed in samples with higher concentrations (indicated by white circle in FIG. 5d).

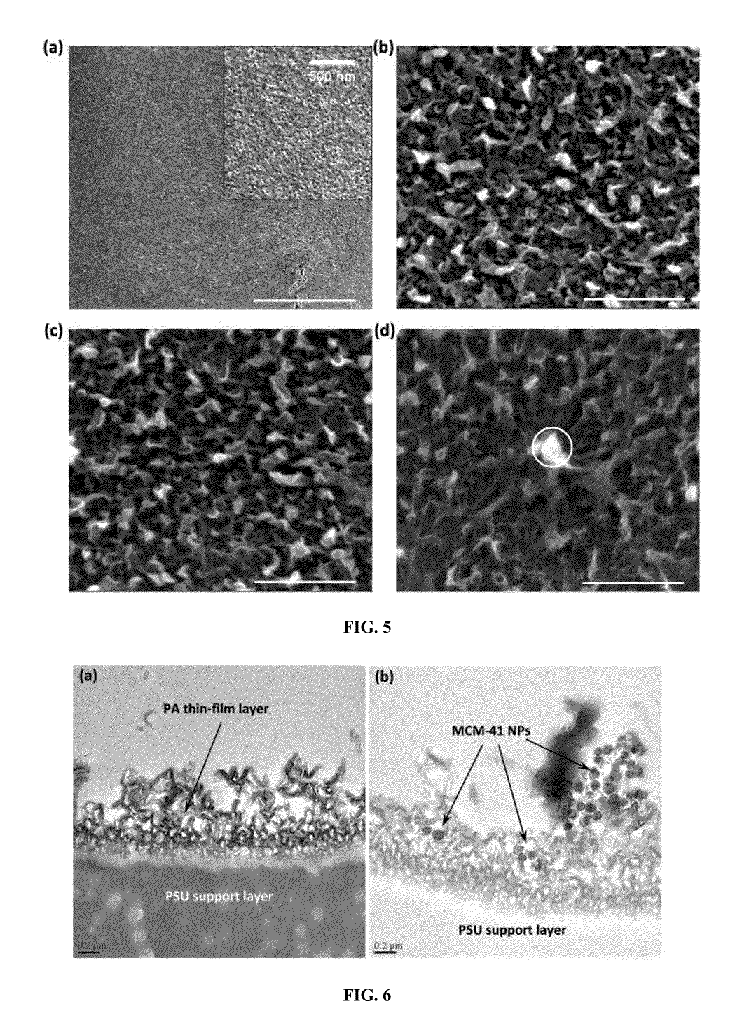

TEM images of the cross-sections of (a) TFC and (b) M-TFN-0.05 membranes (FIG. 6) indicated that the PA thin-film layer in both membranes had a thickness between 300 and 500 nm. The leaf-like structure of PA thin-film layer was consistent with the SEM observation (FIG. 5). The dark spots appeared in the PA thin-film layer of M-TFN membrane (FIG. 6b) indicated the presence of MCM-41 NPs. And aggregation of the MCM-41 NPs could be detected on the surface of thin-film layer in the TEM cross-sectional image.

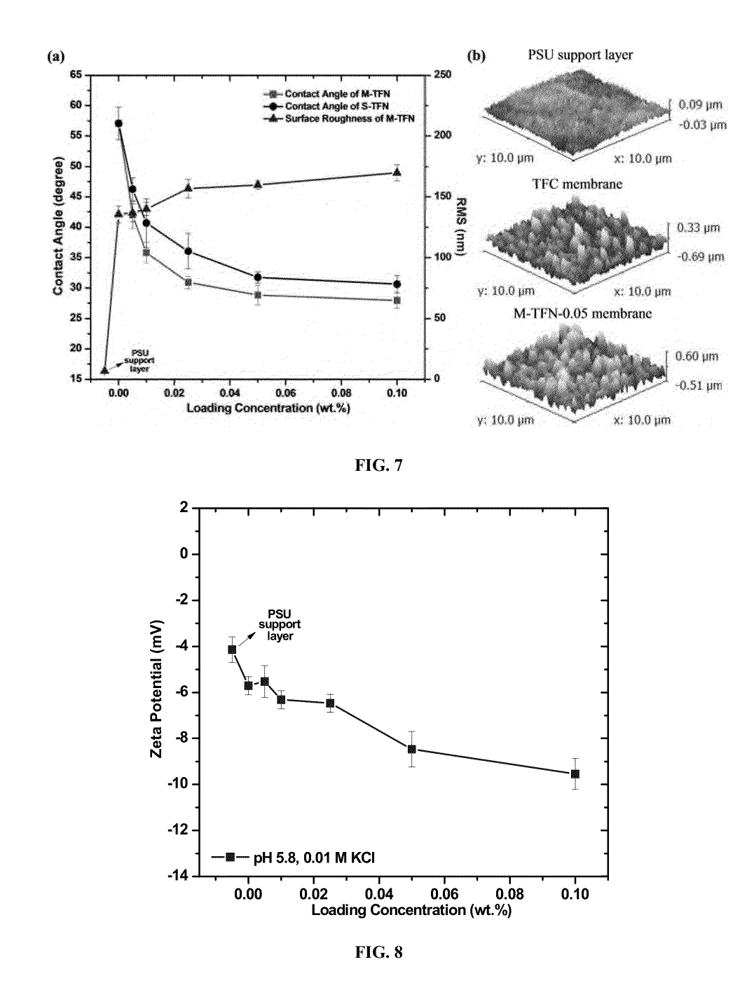

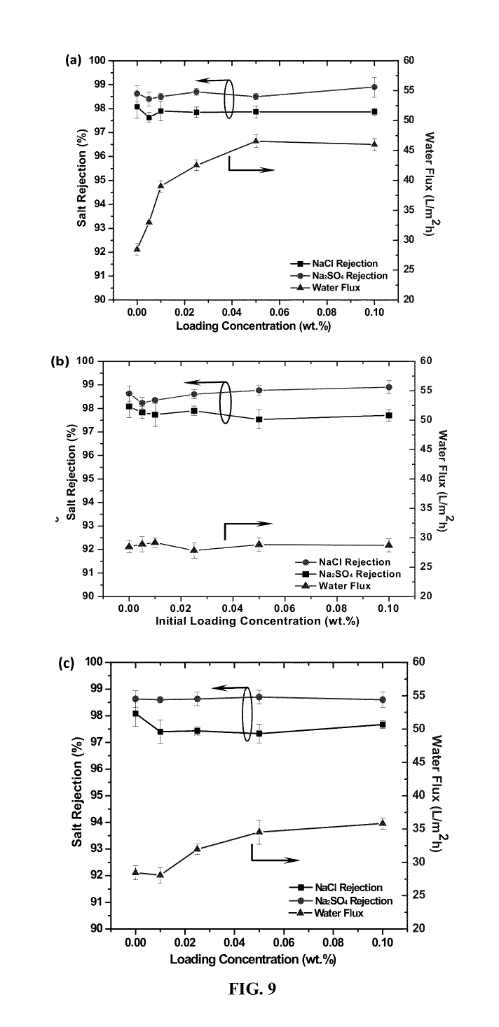

As presented in FIG. 7a, the contact angle of M-TFN membranes decreased from 57.1±2.7° to 27.9±1.3°, while contact angle of S-TFN membranes decreased from 57.1±2.7° to 30.6±1.4° with increasing NPs concentrations from 0 to 0.1 wt. %. The contact angle was decreased to 28.8±1.6° when the concentration of MCM-41 NPs was increased to 0.05 wt. %, then leveled off with further increases of the NPs concentration.

AFM was used to further analyze the morphology of membrane surface. As shown in FIG. 7b, the original PSU support layer was relatively smooth with RMS roughness of 6.8±0.1 nm. The TFC membrane showed much higher surface roughness (135.5±6.8 nm) due to the leaf-like shape of the PA thin-film layer, consistent with the SEM observation (FIG. 5). The RMS value increased to 159.8±3.3 nm in the M-TFN-0.05 membrane, which could be caused by the aggregation of MCM-41 NPs on the membrane surface.

The potentials of membrane surfaces were calculated from the tangential steaming potential measurements and presented in FIG. 8.

### Example 4

### Membrane Permeability and Salt Rejection

A high pressure cross-flow filtration system (pressure range: 50-500 psi) was used to evaluate water flux and solute rejection.

The filter holder (Model: XX4504700, stainless steel, Millipore Corp., Billerica, Mass.) in the test apparatus had an effective membrane area of 9.6 cm². Prior to test, each membrane was compressed by DI water at 300 psi for 5 hrs. Water flux was measured by the weight of the permeate water at a constant transmembrane pressure (TMP). The weight of the permeate water was recorded by a LabVIEW automated system (National Instruments LabVIEW 8.2 with Ohaus digital balance). After pure water flux test, salt solution (final concentration of 2,000 ppm of NaCl or Na₂SO₄) was added and the conductivity of feed and permeate solutions was measured by a conductivity/TDS meter (HACH Company, Loveland, Colo.). The measurement was conducted at 25±1° C., which was controlled by a water circulator (Isotemp 6200 R20F, Fisher Scientific, Inc., Pittsburgh, Pa.). The flux and rejection was calculated with equation (2) and equation (3), respectively.

$$\begin{matrix}J = \frac{{V}_{p}}{A \cdot t} & ( 2 ) \\ R = ( 1 - \frac{{C}_{p}}{{C}_{f}} ) \times 100 & ( 3 )\end{matrix}$$

where J is the water flux (L/m²h), Vₚ is the permeate volume (L), A is the membrane area (m²) and t is the treatment time (hr). R is the rejection ratio and Cₚ and C_{f} are the conductivities of permeate and feed solution, respectively.

Permeate flux from 2000 mg/L NaCl solution and salt rejections of the TFC and TFN membranes were measured at 300 psi of TMP (FIG. 9). TFC membrane rejected NaCl and Na₂SO₄ of 98.1±0.5% and 98.6±0.3%, respectively, which was greatly higher than the salt rejections of the PSU support layer (less than 2%, data not shown).

For the M-TFN membranes (9a), the permeate flux increased from 28.5±1.0 L/m²h to 46.6±1.1 L/m²h (a 63.5% increase) with increasing MCM-41NPs concentration from 0 to 0.1 wt %.

To explore the origin of increased water flux in the TFN membranes, membranes in which MCM-41 NPs were removed from the TMC-hexane solution before the IP process were fabricated and evaluated. The separation of NPs from hexane solution was accomplished by settling for 30 mins and filtration through 0.1 μm Nylon syringe filter (Whatman). The results, as presented in FIG. 9b, showed that the high water flux observed in the M-TFN membranes disappeared when the MCM-41 NPs were prevented from entering the thin-film layer. The similar water fluxes and salt rejections on different conditions eliminate our concern about the potential effects of MCM-41 NPs on the chemical nature of TMC in the hexane solution, and indicated that the chemical nature of TMC monomer was not changed to affect the water flux. Therefore, the MCM-41 NPs must be the critical component of the M-TFN membranes that contributed to the enhanced water flux.

To further investigate the contribution of internal pores of filler, the TFN membrane fabricated with spherical silica NPs without internal pores (S-TFN) was prepared and evaluated. As shown in FIG. 9c, the permeate water flux of S-TFN membranes increased with increasing NPs concentration (28.5±1.0 L/m²h to 35.8±0.9 L/m²h); however, the increased ratio (25.6%) was lower than that of M-TFN membranes (63.5%). M-TFN and S-TFN membranes had the similar NPs chemical property, loading and hydrophilicity; therefore, the flux differences between these two membranes elucidate the important role of internal pores to the increase of water flux, probably by providing short flow paths for water molecules during the filtration process.

The salt rejections of M-TFN and S-TFN membranes changed little with the increase NPs concentrations (FIG. 9). The salt rejections of M-TFN were all above 97.5% for NaCl and 98.5% for Na₂SO₄, while those of S-TFN were maintained above 97% and 98.5% for NaCl and Na₂SO₄, respectively. Na₂SO₄ was better rejected than NaCl.

With an increasing concentration of MCM-41 NPs, hydrophilicity, roughness and zeta potential of the M-TFN membranes all increased. The resultant increase in the permeate water flux was from 28.5±1.0 L/m²h to 46.6±1.1 L/m²h while the salt rejections were maintained essentially the same (97.9±0.3% for NaCl and 98.5±0.2% for Na₂SO₄). When compared with the S-TFN membranes, the M-TFN membranes showed enhanced permeability, suggesting that the short flow paths through the hydrophilic porous structure of MCM-41 NPs had played a role in water permeation.

### Example 5

### Preparation of Micro-Mesoporous Bimodal Silica Nanoparticles (BSN)

Two types of bimodal silica nanoparticles (BSNs) with a particle diameter of 40-90 nm and different internal pore structures were synthesized. Nonaethyleneglycol dodecylether (C₁₂EO_{9, 99}%, Sigma-Aldrich), polyoxyethylene (20) sorbitan monostearate (Tween 60, 99%, Sigma-Aldrich), and tetraethyl orthosilicate (TEOS, 98%, Sigma-Aldrich) were used as surfactants and silica source, respectively, for the synthesis of BSN-T. C₁₂EO₉, eicosaethyleneglycol octadecyl ether (C₁₈EO₂₀, Sigma-Aldrich), and TEOS were used for the synthesis of BSN-C.

BSNs were synthesized as follows: A mixture of C₁₂EO₉, Tween₆₀, and H₂O at a molar ratio of 1:1:60 was mixed for 20 min at 60° C., followed by the addition of TEOS. When the solution was cooled to 20° C., the resulting pasty liquid-crystal (LC) was water-insolubilized by aging for 1 h at 20° C. Then the transparent pre-aged LC phases were immersed in water at 1:250 TEOS, followed by addition of ammonium acetate at an 8:1 molar ratio of ammonium to C₁₂EO₉. The aqueous pH was maintained at 6.6 by adding ammonium acetate. Additional water was added to extract the ethanol produced by the hydrolysis of TEOS and also to promote the condensation reaction. The final material immersed in water was maintained at 20° C. for 7 d. After that, the resulting fully aged soft gel was filtrated, washed initially with water and then repeatedly with ethanol before drying under vacuum. The BSN-T thus obtained were calcinated at 400° C. for 30 min to remove the organic residuals. The reaction in the TEOS/C₁₂EO₉/C₁₈EO₂₀/H₂O system was carried out by a similar procedure using the TEOS/C₁₂EO₉ ratio of 4 and C₁₈EO₂₀ instead of Tween60 to form BSN-C. For a comparative study, C₁₂EO₉-free LC phases in both systems were also prepared. The final products (BSN-T and BSN-C) were stored in a desiccator.

### Example 6

### Characterization of BSNs

The BSNs prepared in Example 5 were characterized for N₂ adsorption/desorption, surface area, and pore size distribution. Internal structures were evaluated by TEM, and size distribution and point of zero charge were measured. SEM analysis was conducted and measurement of pure water contact angles determined. Functional groups of membrane surface were identified, quantitative surface roughness was analyzed, and water flux and solute rejection were evaluated. All of the foregoing were performed as described in Example 2, above.

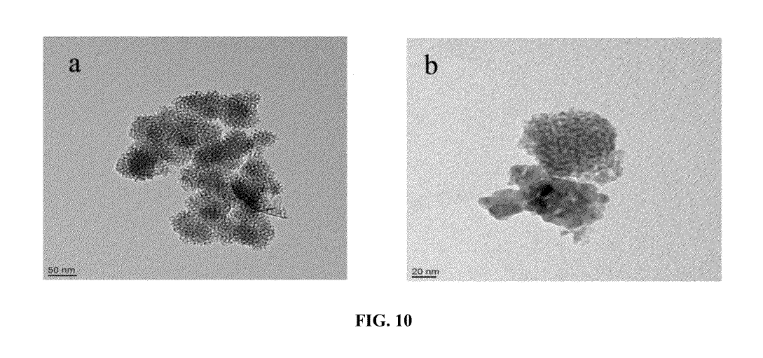

TEM images of both BSN-T (FIG. 10a) and BSN-C (FIG. 10b) indicated they had a near spherical shape. The size of each individual particle was around 40-90 nm with irregularly arranged micropores and mesopores.

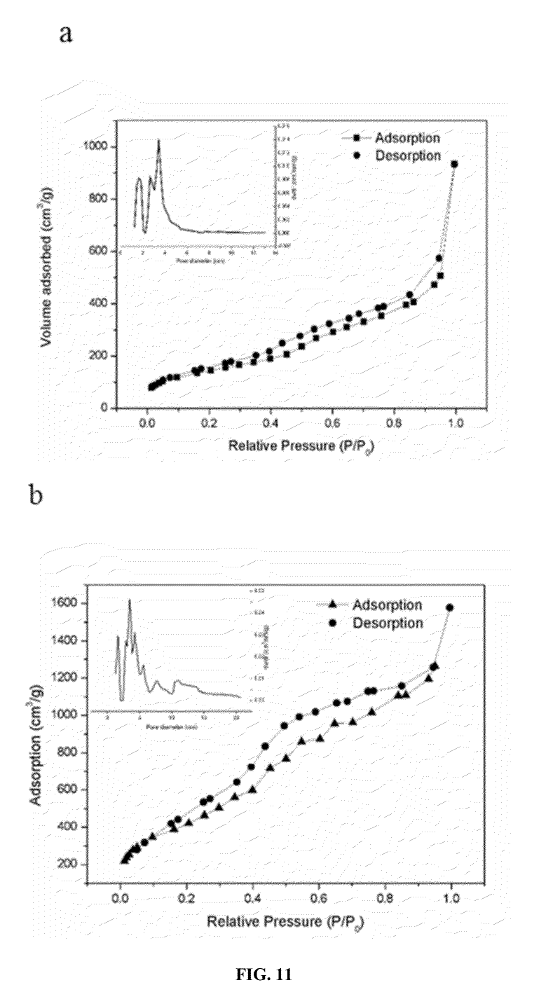

The specific surface area measured by the BET method was 435 m²/g for BSN-T (FIG. 11a), and 1208 m²/g for BSN-C (FIG. 11b), indicating a significant difference in the internal structures between the two NPs. There were micropores for both NPs with a diameter around 1.8 nm. However, BSN-T had mesopores of around 2.5 nm, whereas BSN-C had larger mesopores, around 4 nm. The morphological observations were consistent with the pore distribution obtained from BET data. The result of DLS measurement suggested that BSN-T and BSN-C had mean diameter of 168 and 184 nm, respectively, which was significantly larger than the diameters observed from TEM. This difference could be caused by the hydration layer of water on the particle surface and potential aggregation of BSNs during the DLS measurement. The DLS measurement also indicated that the point of zero charge (PZC) on the surface of these BSNs was 2.23, in agreement with the NPs being-silica in nature.

### Example 7

### Preparation and Characterization of PSU Support Layer and TFN Membrane with BSNs

A PSU support layer was prepared by the method of Example 3, above. The thin film nanocomposite (TFN) membranes incorporating BSN-T and BSN-C were prepared using the method described in Example 3, above, except the PSU support layer with MPD on the surface with placed in a 0.15% TMC-Hexane solution for 1 minute. The amounts of BSNs dispersed in the TMC-hexane solution varied from 0 to 0.1 wt %. The membrane with 0 wt % BSN is a thin-film composite membrane (TFC). The remaining final products were named as BSN-T-TFN-x or BSN-C-TFN-x, where x indicated the concentration of NPs in TMC solution during the interfacial polymerization process.

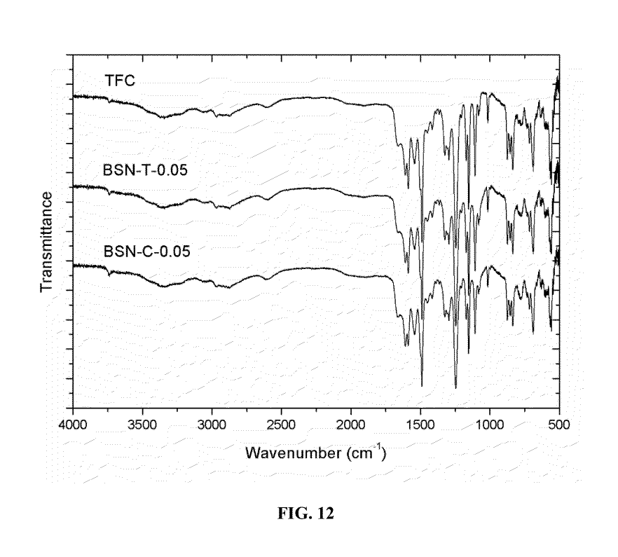

The ATR FT-IR spectra of the TFC and BSN-TFN-0.05 (at loading concentration of 0.05 wt %) membranes are presented in FIG. 12. These results confirmed the existence of BSNs on the surface of the membrane.

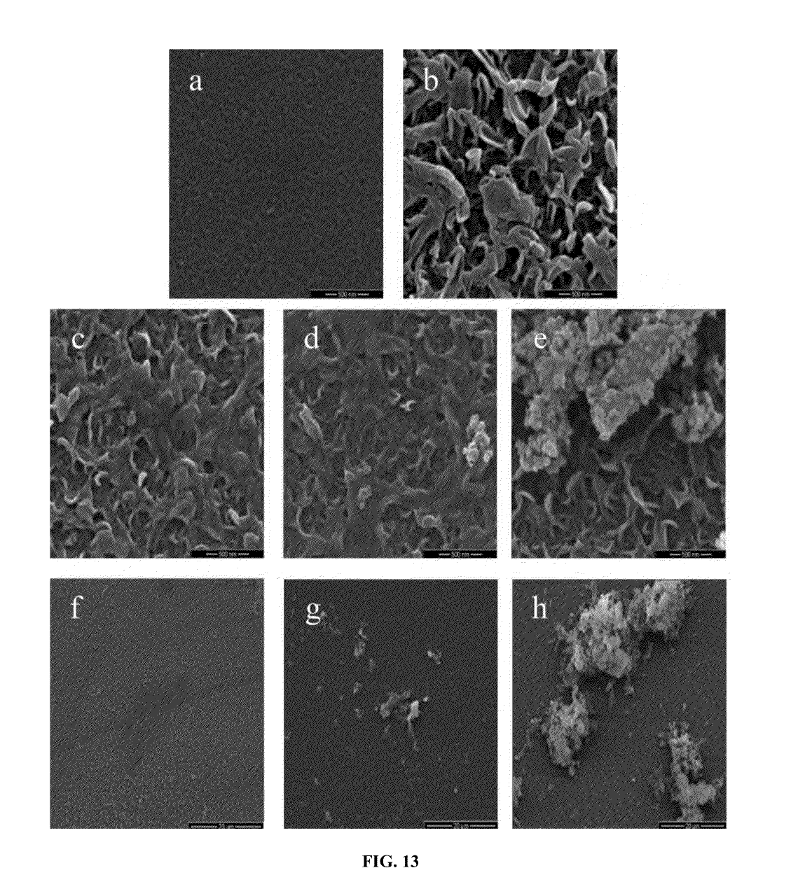

Preventative SEM images of the PSU support layer, and TFC and TFN membranes with different concentrations of BSNs are shown in FIG. 13, as follows: (a) PSU; (b) TFC; (c) BSN-T-0.01 wt %; (d) BSN-T-0.05 wt %; (e) BSN-T-0.1 wt %; (f) TFC (2 μm); (g) BSN-T-0.05 wt % (2 μm); (h) BSN-T-0.1 wt % (2 μm). TFN membranes showed higher surface roughness than that of the TFC membrane. The increased roughness could be the result of NP agglomeration on the membrane surface. In FIG. 13a, pores with diameter around 20 nm were clearly visible on the PSU support layer surface. After the IP process, a PA thin-film layer generated by reaction between MPD and TMC covered the PSU surface, resulting in a leaf-like morphology (FIG. 13b-h). With increasing BSNs concentration, agglomeration occurred (FIG. 13c-e). The agglomeration of BSNs at a concentration of 0.05 wt % was not obvious (FIG. 13d), especially when compared to the case with 0.1% BSNs (FIG. 13e). In other words, BSNs agglomeration became significant with 0.1% or higher BSNs. A lower concentration of BSNs results in a better dispersion of BSNs in the thin-film layer.

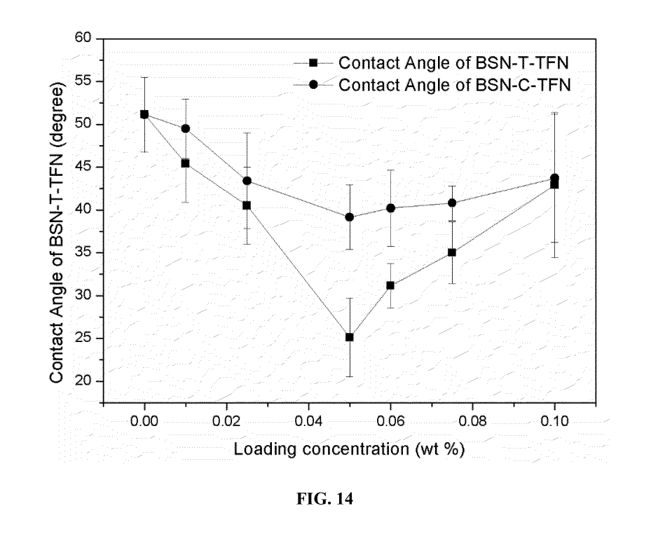

FIG. 14 shows the water contact angles of the TFN membranes with various amounts of BSNs. With increasing BSN concentration, the contact angle of the membrane surface decreased first, reaching a minimum around 0.05 wt %, then leveling off (BSN-C-TFN) or rising up again (BSN-T-TFN). It appeared that the BSN aggregation results in a decrease in the TFN membrane hydrophilicity.

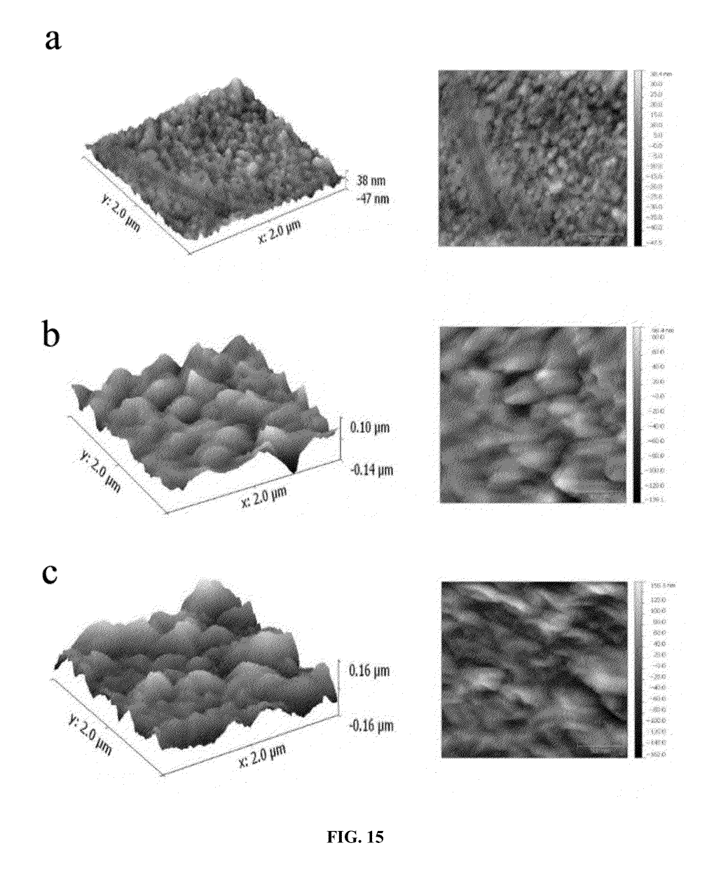

An AFM study was also conducted to evaluate the topography of membrane samples (FIG. 15a (PSU), 15b (TFC), 15c (BSN-T-0.05 wt %). The PSU support layer showed a much smoother surface than that of TFC and TFN membranes. The measured RMS roughness was around 8.64 nm for the PSU support layer, 25.4 nm for the TFC and 43.1 nm for the TFN membrane, indicating that PSU support layer had a much smoother surface.

### Example 8

### Membrane Permeability and Salt rejection

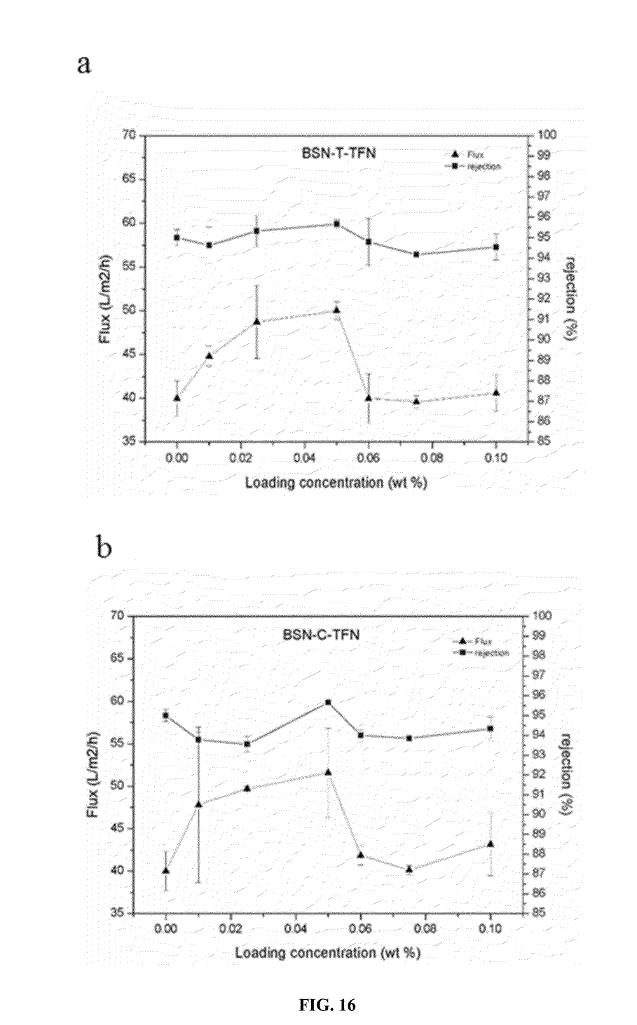

To understand the influence of the BSN concentration on membrane performance, TFN membranes were fabricated with increasing amounts of BSNs in the TMC hexane solution (0.01, 0.025, 0.05, 0.06, 0.075, 0.1 wt %). The membrane performance was assessed in terms of water permeability and NaCl rejection. The tests were conducted with 2000 mg/L NaCl solution under 300 psi (20.4 atm) of trans-membrane pressure (TMP). As shown in FIG. 16b, with increasing BSN-C concentration, the water flux of the membranes increased from an initial value of 38±2.2 L/m²h (without BSNs) to a maximum of 53.5±5.5 L/m²h, and then decreased to 42.5±3.5 L/m²h with a further concentration increase to 0.1 wt %. Membranes with BSN-T demonstrated a similar behavior (FIG. 16a), showing a water flux of 49±2.3 L/m²h at 0.05 wt % but decreased with a further increase in BSN-T loading. Under all loading concentrations of both BSN-C and BSN-T, the rejection of NaCl remained almost constant at around 95±1.2%.

The observed improvement of water flux in the presence of appropriate amounts of BSNs correlated to the membrane contact angle (FIG. 14).

Attempts were made to address the aggregation problems seen with the NPs in TMC-hexane solution when the mass concentration of NPs is over 0.05 wt %. This was done by adding 1 mg/mL of sodium dodecyl sulphate (SDS) into TMC-hexane solution. The results suggest the surfactant plays a distinctive role in the TFN membrane properties. Membranes prepared with surfactant SDS exhibited higher water permeability (from pristine 40±2.83 to 41.85±1.13 L/m²h) but slightly lower salt rejection (from pristine 94.8±1.14 to 91.29±0.89%).

The results in FIG. 16 show the water permeability increased with increasing BSN concentrations, reaching a maximum of 53.5 L/m²h at a BSN concentration of 0.05 wt %. This represented a flux increase of approximately 40%, while a near constant salt rejection of approximately 95% was maintained. The study demonstrated that the internal micro-mesoporous structures of bimodal silica nanoparticles contributed significantly to the membrane performance, and consistent with previous studies with silica nanoparticles of relatively uniform internal pores.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A filtration membrane comprising:
a polymeric membrane film; and
mesoporous silica nanoparticles embedded within the film.

2. The filtration membrane of claim 1, wherein said polymeric membrane film is formed from a solution comprising the nanoparticles, and wherein the nanoparticles comprise less than 0.1 wt % of said nanoparticle solution.

3. The filtration membrane of claim 2, wherein the polymeric film is formed from the nanoparticle solution and a monomer solution comprising a first monomer, and wherein the nanoparticle solution further comprises a second monomer.

4. The filtration membrane of claim 2, wherein said nanoparticles comprise between 0.01 and 0.1 wt % of the nanoparticle solution.

5. The filtration membrane of claim 4, wherein said nanoparticles comprise between 0.04 to 0.05 wt % of the nanoparticle solution.

6. The filtration membrane of claim 1, wherein said nanoparticles are between 2 and 300 nm.

7. The filtration membrane of claim 6, wherein said nanoparticles are between 10 and 200 nm.

8. The filtration membrane of claim 7, wherein said nanoparticles are between 80 and 120 nm.

9. The filtration membrane of claim 1, wherein said nanoparticles have a pore size between 2 and 20 nm.

10. The filtration membrane of claim 9, wherein the nanoparticles have a pore size between 3 and 4 nm.

11. The filtration membrane of claim 1, wherein said nanoparticles comprise pores of at least two sizes.

12. The filtration membrane of claim 11, wherein said nanoparticles comprise micropores and mesopores.

13. The filtration membrane of claim 12, wherein said nanoparticles comprise pores with sizes selected from the group consisting 1.5-2.0 nm, 2.0-2.5 nm and 3.5-4.5 nm.

14. The filtration membrane of claim 1, wherein said nanoparticles are MCM-41 silica nanoparticles.

15. The filtration membrane of claim 1, wherein said nanoparticles are spherical.

16. The filtration membrane of claim 1, wherein said filtration membrane is a thin-film composite membrane.

17. The filtration membrane of claim 16, wherein said filtration membrane is a reverse osmosis or nanofiltration membrane.

18. A thin-film nanocomposite membrane comprising,
a polymeric membrane film;
microporous nanoparticles embedded in said film; and
a porous substrate supporting said film;
wherein said polymeric membrane film is formed from
a monomer solution comprising a first monomer and
a nanoparticle solution comprising the nanoparticles and a second monomer,
wherein said nanoparticles comprise less than 0.1 wt % of the nanoparticle solution.

19. A method for making a filtration membrane comprising:
providing a substrate;
applying a monomer solution comprising a first monomer to a surface of the substrate; and
applying a nanoparticle solution comprising a second monomer and mesoporous silica nanoparticles to the surface of the substrate to form a polymeric membrane film on the substrate.

20. The method of claim 19, wherein the nanoparticles comprise less than 0.1 wt % of the nanoparticle solution.
